(19) United States
(12) Patent Application Publication
(10) Pub. No.: US 2009/0075584 A1
(43) Pub. Date: Mar. 19, 2009

(54) MOBILE BROADCASTING SYSTEM AND METHOD FOR TRANSMITTING AND RECEIVING BROADCAST SERVICE THEREFOR

(75) Inventors: Bo-Sun JUNG, Seongnam-si (KR); Byung-Rae LEE, Seoul (KR); Kook-Heui LEE, Yongin-si (KR); Jae-Yeon SONG, Seoul (KR); Sung-Oh HWANG, Yongin-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/212,495

(22) Filed: Sep. 17, 2008

(30) Foreign Application Priority Data
Sep. 17, 2007 (KR) 2007-94451

(51) Int. Cl. H04H 20/71

(52) U.S. Cl. 455/3.01

(57) ABSTRACT

A method for receiving a broadcast service through a plurality of terminals in a mobile broadcasting system supporting the broadcast service is provided. The method includes sending a registration request message for requesting registration of each of a plurality of terminals from a server associated with a broadcast service, receiving a registration response message from the server in response to each registration request message, sending a service request message to the server through one terminal of the plurality of terminals to request that the broadcast service be provided to the remaining terminals, and receiving, by the remaining terminals, a service response message from the server and the broadcast service.

### PRIORITY

The application claims the benefit under 35 U.S.C. § 119(a) of a Korean patent application filed in the Korean Intellectual Property Office on Sept. 17, 2007 and assigned Ser. No. 2007-94451, the entire disclosure of which is hereby incorporated by reference.

### BACKGROUND OF THE INVENTION

1. Field of the Invention:

The present invention relates to a mobile boradcasting system supporting a broadcast service. More particularly, the present invention relates to a method for receiving and providind broadcast services through multiple terminals and a system therefor.

2. Description of the Related Art:

The mobile communication market faces a continous demand for new services through recombination and/or integration of the exisitng technologies. With the development of communication and broadcasting technologies, the conventional broadcasting system or mobile communication system has reached the phase of providing broadcast services through portable terminals (or mobile terminals) such as a mobile phone, a Personal Digital Assistant (PDA) and the like. Convergence of mobile communication services and Internet Protocol (IP) technology is now considered mainstream in development of next-generation mobile communication technology sue to latent and real market needs, increasing user demand for multimedia services, providers' policies to provide new services such as a broadcast service in addition to existing voice services, and the interests of in Information Telecommunication (IT) enterprises which are strengthening their mobile communication business in accordance with user demands. As a result, various wireless or broadcasting services have been introduced and applied not only in the mobile communication market but also in the Wired communication market, and such omnidirectional convergence has made the same consumption environment for various services regardless of whether it is for wired or wireless broadcasting.

Meanwhile, Open Mobile Alliance (OMA), a standardization group for the interaction between individual mobile solutions, establishes various application standards for mobile games, Internet services, etc. In particular, OMA Mobile Broadcast Working Group (BCAST), which is an OMA working group, is developing the technical standard that provides broadcast services using mobile terminals. OMA BCAST standardizes technology for providing IP-based broadcast services in the portable terminal environment, such as service guide technology, download and streaming delivery technology, service and content protection technology, service subscription technology, roaming technology, etc.

Along with the market trend of providing integrated services due to the above-stated convergence of wired/wireless environments, the mobile broadcasting technology such as OMA BCAST will also evolve to provide services in the wired/wireless integrated environment beyond the mobile environment.

Although the following description will be made with reference to OMA BCAST technology, to provide a better understanding of the present invention, it is not intended to limit the present invention thereto.

FIG. 1 is a diagram illustrating a logical configuration of a conventional mobile broadcasting system proposed by OMA BCAST. FIG. 1 illustrates an Application Layer and its lower Transport Layer and Network Layer in the mobile broadcasting system.

In OMA BCAST, the technical fields and functions now under consideration for mobile broadcasting services include Service Guide for discovering mobile broadcasting services, Service Recovery, Streaming File Transfer, Service & Content Protection, Service Provisioning, Interaction between a mobile broadcasting network and a cellular network, Notification capable of notifying a start of and a change in the mobile broadcasting service, etc. Such functions are performed by the BCAST logical entities illustrated in FIG. 1.

A description will now be made of the logical entities and interfaces shown in FIG. 1.

A Content Creation (CC) 101 is a provider of contents that are the base of the BCAST service. For example, the BCAST service can include the conventional audio/video broadcast service, file download service for music files and data files, etc. The Content Creation 101 provides a BCAST Service Application 103 with attributes for the contents, used for creating a service guide and determining a transport bearer over which the service will be delivered.

The BCAST Service Application 103 receives data of the BCAST service provided from the Content Creation 101, and processes it into a form suitable to provide media encoding, content protection, interactive service, etc. In addition, the BCAST Service Application 103 provides the attributes for the contents, provided from the Content Creation 101, to a BCAST Service Distribution/Adaptation 105 and a BCAST Subscription Management 107.

The BCAST Service Distribution/Adaptation 105 performs operations such as file and streaming delivery, service collection, service protection, service guide creation and delivery, and service notification, using the BCAST service data provided from the BCAST Service Application 103. In addition, the BCAST Service Distribution/Adaptation 105 adapts the service so that it is suitable for a Broadcast Distribution System 113.

The BCAST Subscription Management 107 manages, by hardware or software, service provisioning such as subscription and charge-related function of a BCAST service user, provisioning of information used for the BCAST service, and a terminal receiving the provided BCAST service.

A Terminal 109 receives content/service guide and program support information such as content protection, and provides broadcast services to the user.

A BDS Service Distribution 111 delivers mobile broadcasting services to multiple terminals through mutual communication with the Broadcast Distribution System 113 and an Interaction Network 115.

The Broadcast Distribution System 113 delivers mobile broadcasting services over a broadcast channel, and can be, for example, at least one of a Multimedia Broadcast Multicast Service (MBMS) defined by the 3^{rd} Generation Partnership Project (3GPP) which is the 3^{rd} generation asynchronous mobile communication standard group, a Broadcast Multicast Service (BCMCS) proposed by the 3^{rd} Generation Partnership Project 2 (3GPP2) which is the 3^{rd} generation synchronous mobile communication standard group, a DVB-Handheld (DVB-H) defined by Digital Video Broadcasting (DVB) which is the digital broadcasting standard group, and an IP-based broadcasting/communication network.

The Interaction Network 115 provides an interaction channel, and can be, for example, a cellular network.

A description will now be made of reference points that are connection paths between the above-stated logical entities.

BCAST-1 121 is a transmission path for contents and content attributes.

BCAST-2 123 is a transmission path for a content-protected or content-unprotected BCAST service, and attributes and content attributes of the BCAST service.

BCAST-3 125 is a transmission path for attributes of a BCAST service, attributes of contents, user preference and subscription information, user request, and response to the request.

BCAST-4 127 is a transmission path for a notification message, attributes used for a service guide, and a key used for content protection and service protection.

BCAST-5 129 is a transmission path for protected BCAST service, unprotected BCAST service, content-protected BCAST service, content-unprotected BCAST service, BCAST service attributes, content attributes, notification, service guide, Digital Right Management (DRM) Right Object (RO) used for BCAST service protection, security material such as key value, and all data and signals transmitted over a broadcast channel.

BCAST-6 131 is a transmission path for protected BCAST service, unprotected BCAST service, content-protected BCAST service, content-unprotected BCAST service, BCAST service attribute, content attributes, notification, service guide, DRM RO used for BCAST service protection, security material such as a key value, and all data and signals transmitted over an interaction channel.

BCAST-7 133 is a transmission path for service provisioning, subscription information, device management, DRM RO used for BCAST service protection, and user preference information transmitted over an interaction channel of control information related to reception of security material such as a key value.

BCAST-8 135 is a transmission path over which user data for the BCAST service is subject to interaction.

BDS-1 137 is a transmission path for protected BCAST service, unprotected BCAST service, BCAST service attribute, content attribute, notification, service guide, DRM RO used for BCAST service protection, and security material such as a key value.

BDS-2 139 is a transmission path for service provisioning, subscription information, device management, DRM RO used for BCAST service protection, and security material such as a key value.

X-1 141 is a reference point between the BDS Service Distribution 111 and the Broadcast Distribution System 113.

X-2 143 is a reference point between the BDS Service Distribution 111 and the Interaction Network 115.

X-3 145 is a reference point between the Broadcast Distribution System 113 and the Terminal 109.

X-4 147 is a reference point between the BDS Service Distribution 111 and the Terminal 109 over a broadcast channel.

X-5 149 is a reference point between the BDS Service Distribution 111 and the Terminal 109 over an interaction channel.

X-6 151 is a reference point between the Interaction Network 115 and the Terminal 109.

In the foregoing description, the term “reference point” denotes a connection path between two arbitrary logical entities, and has multiple interfaces according to their purposes. Such interfaces are used for communication between more than two logical entities for an arbitrary purpose, and a message format and a protocol suitable for the purpose are used.

The conventional technology considers one terminal for one user. In addition, a service subscription and a reception request are made in the same terminal. That is, only the terminal that applied for the service subscription can perform a service reception. At present, the terminals used by one user can include a mobile phone, a Personal Computer (PC), a Set-Top Box (STB), etc, and the user can achieve the service reception with a proper terminal according to a location and time. Therefore, there is a need for a method capable of allowing the user to receive the same service through his/her various terminals, taking into consideration the current technology and market trend in which wired and wireless TV service markets are being integrated.

### SUMMARY OF THE INVENTION

An aspect of the present invention is to address at least the above-mentioned problems and/or disadvantages and to provide at least the advantages described below. Accordingly, an aspect of the present invention is to provide a method in which a user can register a plurality of terminals, and receive a service through any one of the terminals registered during a service request in a mobile broadcasting system, and a system therefor.

Another aspect of the present invention is to provide a method capable of receiving a service through one of a plurality of terminals according to a location and time even when it is not possible to receive the corresponding service as scheduled, and a system therefor.

Another aspect of the present invention is to provide a method capable of receiving a service through various terminals, and a system therefor.

According to one aspect of the present invention, a method for receiving a broadcast service through a plurality of terminals in a mobile broadcasting system is provided. The method includes sending a registration request message for requesting registration of each of a plurality of terminals from a server associated with a broadcast service, receiving a registration response message from the server in response to each registration request message, sending a service request message to the server through one terminal of the plurality of terminals to request that the broadcast service be provided to the remaining terminals, and receiving, by the remaining terminals, a service response message from the server and the broadcast service.

According to another aspect of the present invention, a method for providing a broadcast service through a plurality of terminals in a mobile broadcasting system is provided. The method includes, upon receipt of a registration request message for each of a plurality of terminals, registering the plurality of terminals and sending a registration response message in response to each registration request message, receiving a service request message through one terminal of the plurality of terminals, the service request message requesting that a broadcast service be provided to the remaining terminals, and sending a service response message and the broadcast service to the remaining terminals.

According to further another aspect of the present invention, a mobile broadcasting system for providing a broadcast service to a plurality of terminals is provided. The mobile broadcasting system includes a plurality of terminals for receiving the broadcast service, and a server for receiving a registration request message for each of the plurality of terminals, for registering the plurality of terminals, for sending a registration response message in response to each registration request message, for receiving a service request message through one terminal of the plurality of terminals, the service request message requesting that the broadcast service be provided to the remaining terminals, and for sending a service response message and the broadcast service to the remaining terminals.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a diagram illustrating a logical configuration of a conventional mobile broadcasting system proposed by OMA BCAST;

FIG. 2 is a diagram illustrating a configuration for service provisioning in OMA BCAST according to an exemplary embodiment of the present invention;

FIG. 3 is a diagram illustrating a broadcast service reception procedure according to an exemplary embodiment of the present invention;

FIG. 4 is a control flowchart for terminal registration according to a first exemplary embodiment of the present invention;

FIG. 5 is a control flowchart for terminal registration according to a second exemplary embodiment of the present invention;

FIG. 6 is a control flowchart for broadcast service reception according to an exemplary embodiment of the present invention; and

FIGS. 7A and 7B are control flowcharts for broadcast service reception in OMA BCAST according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the exemplary embodiments described herein can be made without departing from the scope and spirit of the invention. In addition, descriptions of well-known functions and constructions are omitted for clarity and conciseness.

Although a detailed description of exemplary embodiments of the present invention will be given herein using the names of entities defined by the 3^{rd} Generation Partnership Project (3GPP) or Open Mobile Alliance (OMA) BCAST to provide a better understanding of the present invention, it is not intended to limit the scope of the present invention to the standards and the names of entities referred to herein, and the present invention can be applied to any system having similar technical background.

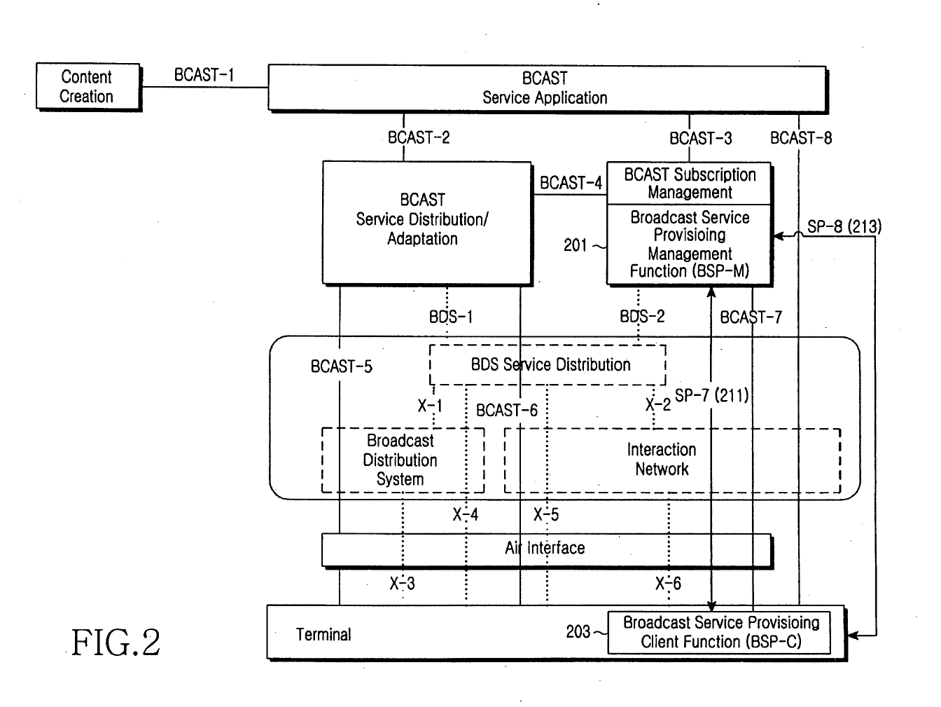

FIG. 2 is a diagram illustrating a configuration for service provisioning in OMA BCAST according to an exemplary embodiment of the present invention.

A Broadcast Service Provisioning Management Function (BSP-M) provided in the BCAST Subscription Management 201 serves to provide subscription and service purchase information. The BSP-M provides billing information of a user to a relevant entity according to subscription information of the user, and supports billing on the mobile broadcasting service. In addition, the BSP-M delivers reports over interfaces of SP-7 211 and SP-8 213 in response to a subscription request and a billing and private information request from the user.

A Broadcast Service Provisioning Client Function (BSP-C) 203 in the mobile terminal serves to make a report on subscription to the BCAST service and service use. The BSP-C 203 can extract provisioning information for subscription/purchase from a service guide to make a request for subscription/purchase or make a request for additional information.

The service provisioning takes charge of a user subscription to the BCAST service and a purchase for the subscribed service. In addition, the service provisioning provides additional information on payment/purchase such as status information of the user account. A description of the SP-7 211 and the SP-8 213 is given in Table 1.

TABLE 1

| | Interface | Reference Point | Usage |
|---|---|---|---|
| 211 | SP-7 | BCAST-7 | Delivery of messages used for |
| | | | a subscription such as subscription |
| | | | request of user and response |
| | | | from BCAST Subscription |
| | | | Management. Delivery of |
| | | | payment information |
| 213 | SP-8 | Out of band | The End User subscribes and |
| | | | purchases the services through |
| | | | the out-of-band interfaces. Itis |
| | | | out of the scope of OMA BCAST. |

Before a description of the present invention is given, a definition will be given of a message schema table used in an exemplary embodiment of the present invention.

TABLE 2

| | | | | | |
|---|---|---|---|---|---|
| Name | Type | Category | Cardinality | Description | Data Type |

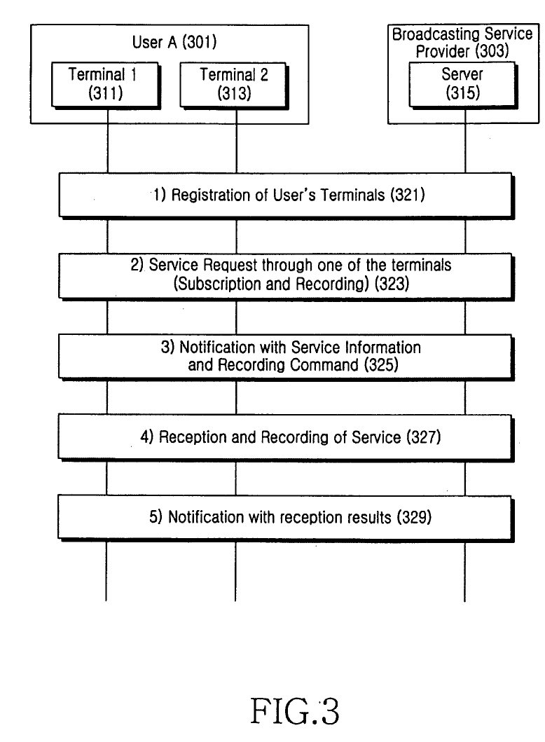

In Table 2, ‘Name’ indicates names of elements and attributes constituting a corresponding message. ‘Type’ indicates whether a type of the corresponding name is an element or an attribute. The elements have values of E1, E2, E3 and E4. E1 indicates an upper element for the entire message, E2 indicates a lower element of E1, E3 indicates a lower element of E2, and E4 indicates a lower element of E3. The attribute(s) is denoted by ‘A’, and indicates an attribute of the corresponding element. For example, ‘A’ under E1 indicates an attribute of E1. ‘Category’ is used for determining whether the corresponding element or attribute is mandatory or not, and it has a value M for mandatory and a value 0 for optional. ‘Cardinality’ indicates a relationship between elements, and has a value of 0, 0 . . . 1, 1, 0 . . . n, 1 . . . n, where ‘0’ denotes an optional relation, ‘1’ denotes a mandatory relation, and ‘n’ denotes the possibility of having a plurality of values. For example, ‘0 . . . n’ denotes that the corresponding element may not exist or may have n values. ‘Description’ indicates the meaning of the corresponding element or attribute, and ‘Data Type’ indicates a data type for the corresponding element or attribute. FIG. 3 is a diagram illustrating a broadcast service reception procedure according to an exemplary embodiment of the present invention.

When User_A 301 has a plurality of terminals, such as Terminal_1 311 and a Terminal_2 313, User_A 301 registers the terminals in a server 315 associated with the broadcasting service provider 303 in step 321, and sends, in step 323, a service request through one of the plurality terminals for service reception, requesting the server 315 to provide the service through the remaining terminal(s). After the service request is granted, the server 315 sends in step 325 a notification with service information, reception information and a service start command to the terminals desiring to receive the service. In step 327, the User_A 301 receives and records the service with the terminals desiring to receive the service, and the server 315 sends in step 329 a notification with the recording completion results to the terminal used in step 323. While Terminal_1 311 and a Terminal_2 313 are described herein as an example of User_A's 301 plurality of terminals, the present invention is not limited thereto. Exemplary embodiments of the present invention may be implemented for use by any number of users each having any number terminals.

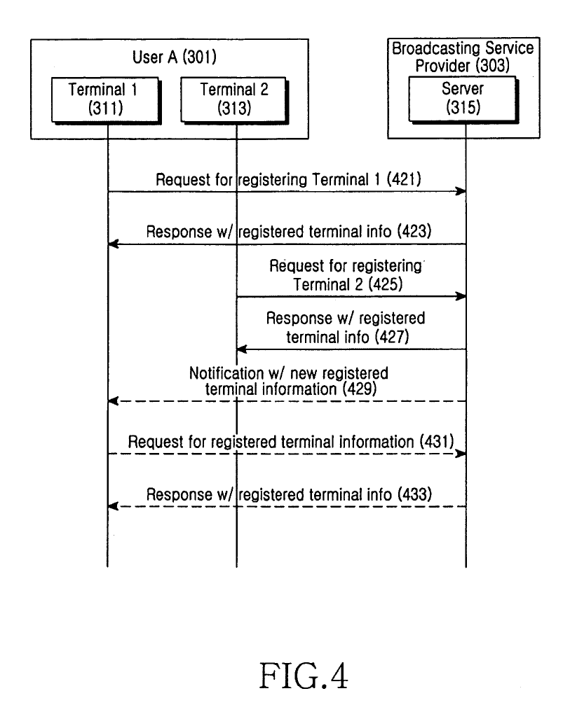

With reference to FIG. 4, a description will now be made of a first exemplary embodiment for the terminal registration in step 321 illustrated in FIG. 3. It should be noted herein that the processes shown by dotted lines may be omitted in certain exemplary embodiments of the present invention.

FIG. 4 is a control flowchart for terminal registration according to the first exemplary embodiment of the present invention.

In step 421, the User_A 301 sends a terminal registration request message for the Terminal_1 311 to the server 315 associated with the broadcasting service provider 303 through the Terminal_1 311. Upon receipt of the terminal registration request message for the Terminal_1 311, the server 315 sends a response message in response to the terminal registration request to the Terminal_1 311 in step 423, and if there is information on any previously registered terminal, the server 315 sends the response message with the registered terminal information to the Terminal_1 3 11. In step 425, the User_A 301 sends a terminal registration request message for another terminal, Terminal_2 313, to the server 315 through the Terminal_2 313. Upon receipt of the terminal registration request message for the Terminal_2 313, the server 315 sends a response message in response to the terminal registration request in step 427. Thereafter, in step 429, the server 315 may send a notification to the Terminal_1 311 that is the previously registered terminal, informing Terminal_1 311 that the Terminal_2 313 is newly registered.

When there is no notification procedure of step 429, the Terminal_1 311 may send in step 431 to the server 315 a request for information on all terminals currently registered for the User_A 301, and may receive in step 433 the information on all the registered terminals.

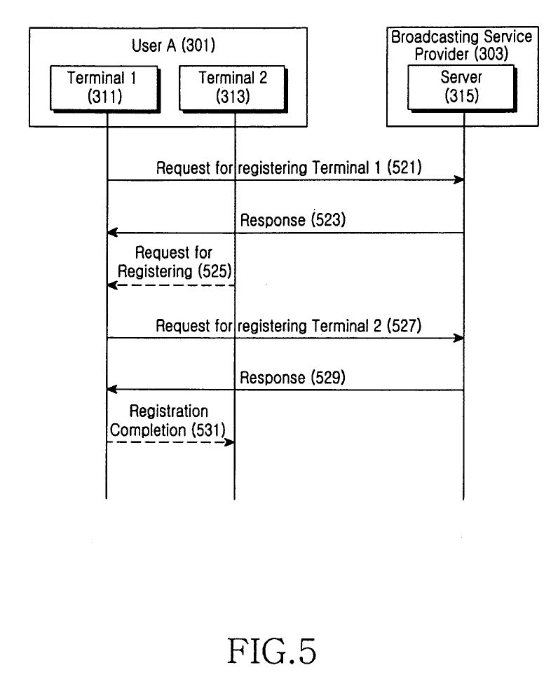

With reference to FIG. 5, a description will now be made of a second exemplary embodiment for terminal registration in step 321 of FIG. 3.

FIG. 5 is a control flowchart for terminal registration according to the second exemplary embodiment of the present invention.

The second exemplary embodiment described below is different from the first exemplary embodiment in that the user initiatively registers all terminals through a master terminal. The User_A 301 sends in step 521 a registration request message for a corresponding terminal, Terminal_1 311, to the server 315 associated with the broadcasting service provider 303 through the Terminal_1 311. In this process, the User_A 301 informs the server 315 that the corresponding terminal, Terminal_1 311, is a master terminal of the User A 301. Upon receipt of the registration request message, in step 523, the server 315 sends to the Terminal_1 311 a response message for the results on the registration procedure for the corresponding terminal. In step 525, another terminal, Terminal_2 313, may send a terminal registration request message to the Terminal_1 311, which is the master terminal of the User_A 301. Upon receipt of the request message, the Terminal_1 311 sends a registration request message for the Terminal_2 313 to the server 315 in step 527. Upon receipt of the request message, the server 315 sends a response message to the terminal registration request to the Terminal_1 311 in step 529. Upon receipt of the response message, the Terminal_1 311 may notify the Terminal_2 313 in step 531 that the registration procedure for the Terminal_2 313 is completed.

Although it is assumed in the foregoing description that the user registers all his/her terminals through the master terminal, any one of the user's terminals can be the master terminal. Therefore, in the process of sending a registration request message for a corresponding terminal to the server 315 through the Terminal_1 311 as in step 521, the user may inform the server 315 that the corresponding terminal is a master terminal of the User_A 301, or may perform registration of other terminals through an arbitrary terminal without appointing a master terminal.

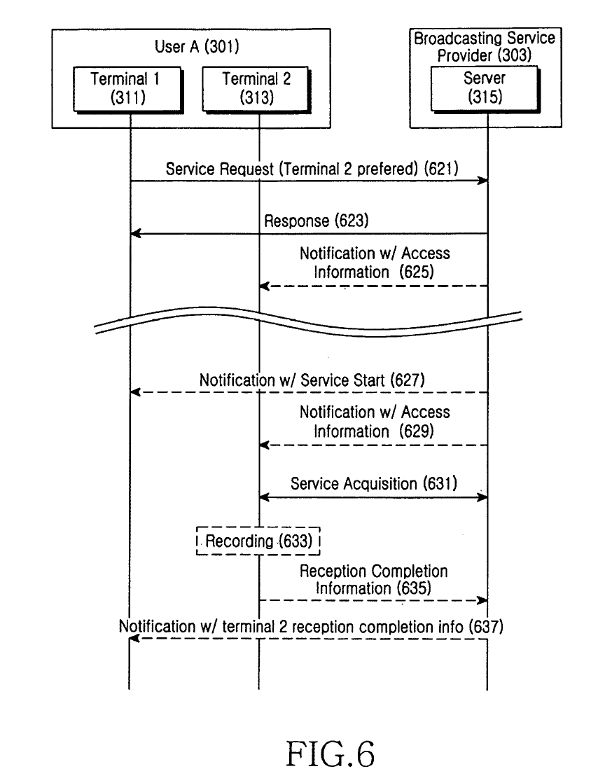

With reference to FIG. 6, a detailed description will now be made of steps 323-329 of FIG. 3.

FIG. 6 is a control flowchart for broadcast service reception according to an exemplary embodiment of the present invention.

After undergoing the terminal registration process of FIG. 4 or FIG. 5, the User_A 301 sends, in step 621, a request message for a broadcast service to the server 315 associated with the broadcasting service provider 303 through the Terminal_1 311, requesting that he/she will receive the broadcast service with the Terminal_2 313. Upon receipt of the request message, the server 315 sends a response message with the processing results on the request to the Terminal_1 311 in step 623. When the server 315 accepts the corresponding request, the server 315, upon its request acceptance, may send in step 625 a notification message with schedule, access information and recording information for the corresponding service to the Terminal_2 313, or may send in step 629 a notification message indicating a start of the service before the service starts. In this case, the server 315 may send in step 627 a notification message indicating a start of the service to the Terminal_1 311. Upon receipt of the notification message with the information related to service reception such as schedule, access information and recording information for the corresponding service, the Terminal_2 313 acquires and receives the service provided from the server 315 according to a schedule of the corresponding service in step 631. The corresponding service can be received regardless of the broadcast or interaction network. Upon the service reception, the Terminal_2 313 may store (record) the received contents in step 633, and after completion of the recording, send in step 635 reception completion information to server 315. After service delivery completion, the server 315 may send a notification message for service reception completion to the Terminal_311 instep 637.

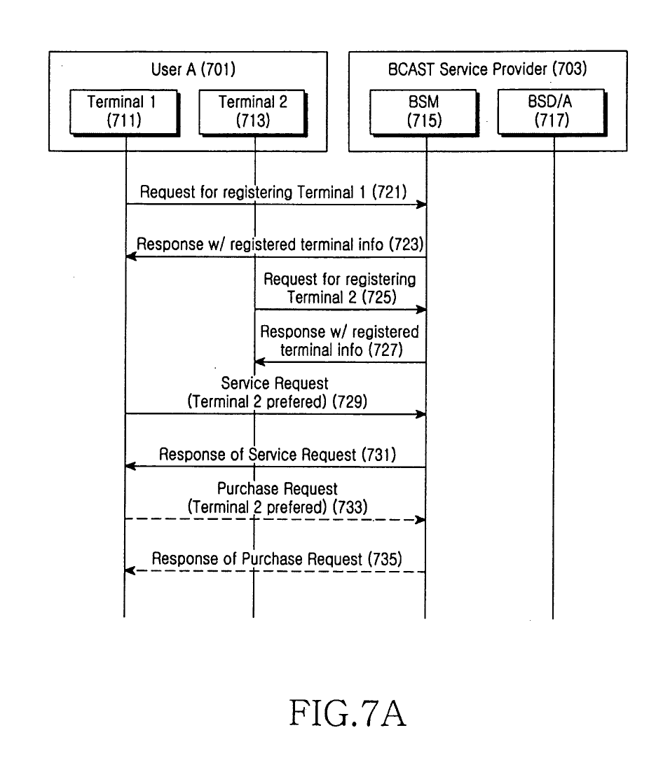

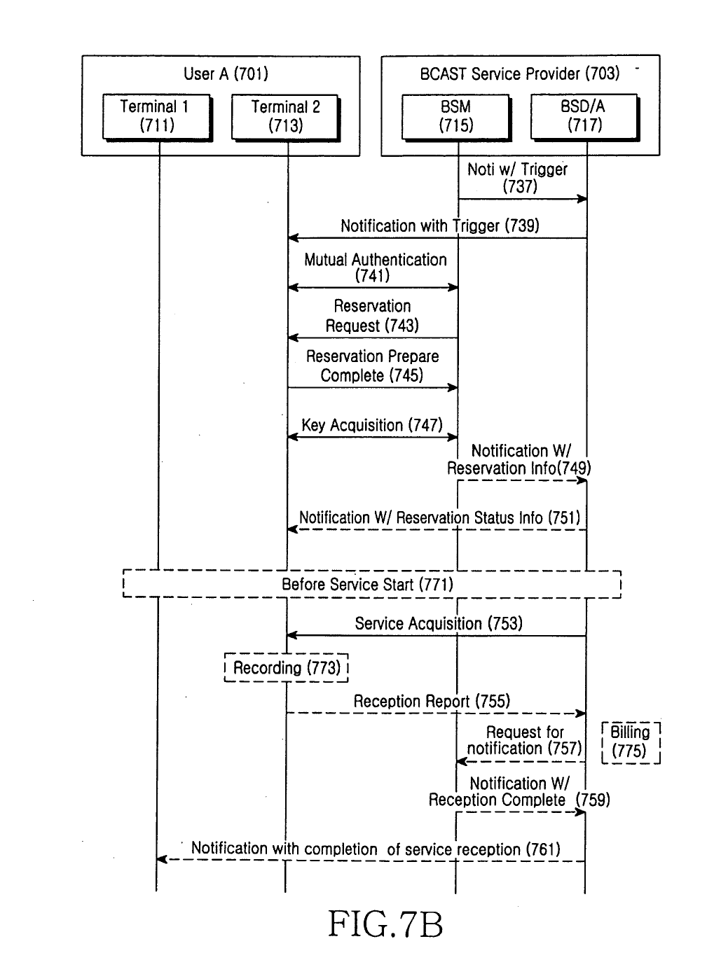

With reference to FIGS. 7A and 7B, a description will now be made of an operation applied by OMA BCAST.

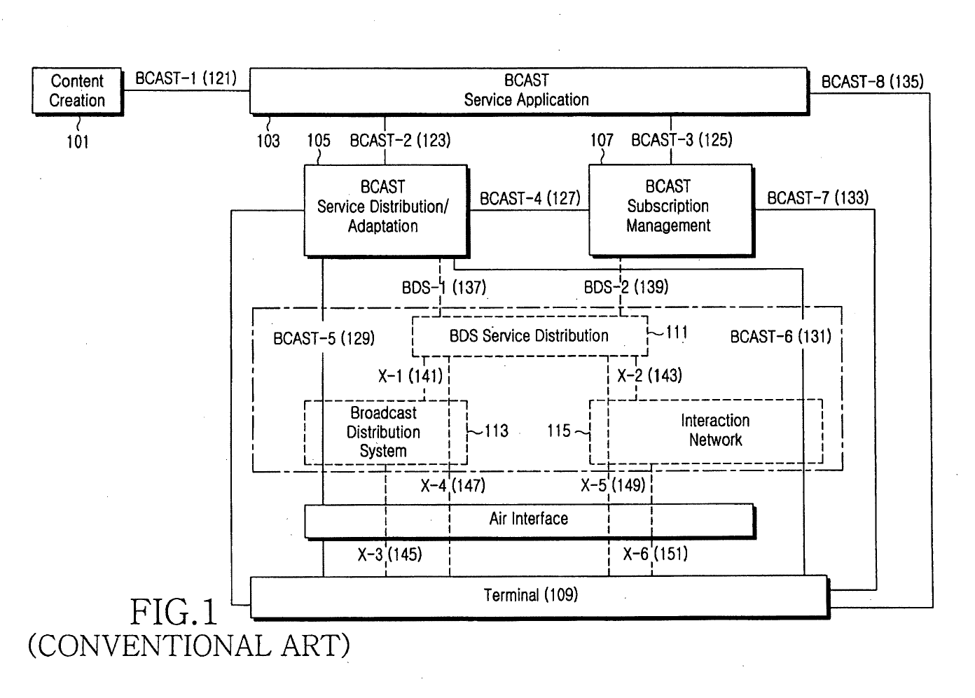

FIGS. 7A and 7B are control flowcharts for broadcast service reception in OMA BCAST according to an exemplary embodiment of the present invention. In step 721, a User_A 701 sends a terminal registration request message for a Terminal_1 711 to a Broadcast Subscription Management (BSM) (i.e. BCAST Subscription Management 107 of FIG. 1) 715 associated with BCAST Service Provider 703 through the Terminal_1 711. Upon receipt of the terminal registration request message for the Terminal_1 711, the BSM 715 sends a response message indicating the request processing results to the Terminal_1 711 in step 723. In step 725, the User_A 701 sends a terminal registration request message for another terminal Terminal_2 713 to the BSM 715 through the Terminal_2 713. Upon receipt of the terminal registration request message for the Terminal_2 713, the BSM 715 sends a response message indicating the request processing results in step 727. Through steps 721˜727, each terminal requests the BSM 715 to register information on the corresponding terminal using the terminal registration request message shown in Table 3.

TABLE 3

| | | | | | Data |
|---|---|---|---|---|---|
| Name | Type | Category | Cardinality | Description | Type |
| TregReq | E | | | Terminal | |
| | | | | registration | |
| | | | | request message | |
| userID | A | M | 1 | User identifier | anyURI |
| Device | E1 | M | 1 . . . N | Terminal | anyURI |
| | | | | information | |
| Id | A | M | 1 | Terminal | string |
| | | | | identifier | |
| Name | A | M | 0 . . . 1 | Terminal name | string |
| | | | | (for management) | |

After completion of processing on the request message, the BSM. 715 sends the terminal registration results to the Terminal_1 711 and the Terminal_2 713 through a terminal registration response message of Table 4 in steps 723 and 727, together with information on all terminals registered in the BSM 715.

TABLE 4

| Name | Type | Category | Cardinality | Description | TData ype |
|---|---|---|---|---|---|
| TregRes | E | | | Terminal registration request message | |
| statusCode | A | M | 1 | Request result code | unsignedByte |
| Device | E1 | M | 1 . . . N | Terminal information | anyURI |
| Type | A | M | 1 | Identifier type | unsignedByte |
| Id | A | M | 1 | terminal identifier | string |
| name | A | M | 0 . . . 1 | Terminal name (for management) | string |

In step 729, the Terminal_1 711 sends a service request message of Table 5 to the BSM 715, requesting that the User_A 701 receive the broadcast service with the Terminal_2 713.

TABLE 5

| Name | Type | Category | Cardinality | Description | Data Type |
|---|---|---|---|---|---|
| ServiceResponse | E | | | Response to Rx terminal-appointed service request | |
| statusCode | A | M | 1 | Processing result (success or failure reason) | unsignedByte |
| PurchaseInfo | E1 | M | 0 . . . 1 | Price information upon occurrence of additional | |
| | | | | fee and purchase | |
| globalPurchaseItemID | A | M | 1 | Purchase Item identifier corresponding to purchase | anyURI |
| Price | E2 | M | 1 | Price information for corresponding item | double |
| Currency | A | M | 1 | Currency type | string |

In step 731, the BSM 715 sends a response message, which is a response to the broadcast service reception request, to the Terminal_1 711 through a message of Table 6, and when there is a need for an additional fee and purchase, the BSM 715 sends a response message including the details necessary for the purchase, such as item information and price information.

TABLE 6

| Name | Type | Category | Cardinality | Description | Data Type |
|---|---|---|---|---|---|
| ServiceResponse | E | | | Response to Rx terminal-appointed service request | |
| statusCode | A | M | 1 | Processing result (success or failure reason) | unsignedByte |
| PurchaseInfo | E1 | M | 0 . . . 1 | Price information upon occurrence of additional | |
| | | | | fee and purchase | |
| globalPurchaseItemID | A | M | 1 | Purchase Item identifier corresponding to purchase | anyURI |
| Price | E2 | M | 1 | Price information for corresponding item | double |
| Currency | A | M | 1 | Currency type | string |

In Table 5 and Table 6, elements can be additionally defined or a separate message can be defined so that a reception request through a particular terminal can be specified in the defined message corresponding to the service subscription and purchase.

The User_A 701, when he/she receives a broadcast service using the 713, checks in step 731 subscription/purchase information such as a separate fee payment through a response message that is a response to the service request, by means of the Terminal_2 713. The User_A 701, if he/she intends to perform subscription/purchase, may send a subscription/purchase request to the BSM 715 in step 733 using a service request message corresponding to the subscription/purchase, which is defined in BCAST as shown in Table 7.

TABLE 7

| | | | | | Data |
|---|---|---|---|---|---|
| Name | Type | Category | Cardinality | Description | Type |
| ServiceRequest | E | | | Service Request Message to subscribe or | |
| | | | | purchase PurchaseItem | |
| | | | | Contains the following attributes: | |
| | | | | requestID | |
| | | | | Contains the following elements: | |
| | | | | UserID | |
| | | | | DeviceID | |
| | | | | ServiceEncryptionProtocol | |
| | | | | PurchaseItem | |
| | | | | DrmProfileSpecificPart | |
| | | | | SmartcardProfileSpecificPart | |
| | | | | Note: The Service Request message MAY | |
| | | | | contain either the DrmProfileSpecificPart or | |
| | | | | SmartcardProfileSpecificPart, but not both. | |
| | | | | Furthermore, in the case of the Smartcard | |
| | | | | Profile, the ‘SmartcardProfileSpecificPart’ | |
| | | | | SHALL be omitted if the message is used for | |
| | | | | the purpose of subscription or purchase, and | |
| | | | | SHALL be included if the message is used to | |
| | | | | request delivery of SEK(s)/PEK(s). | |
| requestID | A | O | 0 . . . 1 | Identifier for the Service request message. | unsignedInt |
| UserID | E1 | O | 0 . . . N | The user identity known to the BSM. Contains | string |
| | | | | the following attributes: | |
| | | | | type | |
| type | A | M | 1 | Specifies the type of User ID. Allowed values | unsignedByte |
| | | | | are: | |
| | | | | 0 - username defined in [RFC 2865] | |
| | | | | 1 - IMSI | |
| | | | | 2 - URI | |
| | | | | 3 - IMPI | |
| | | | | 4 - MSISDN | |
| | | | | 5 - MIN | |
| | | | | 6-127 reserved for future use | |
| | | | | 128-255 reserved for proprietary use | |
| DeviceID | E1 | O | 0 . . . N | A unique device identification known to the | string |
| | | | | BSM. This element SHALL be included when | |
| | | | | the device supports the DRM profile. In this | |
| | | | | case, the device shall not allow the user to | |
| | | | | modify the DeviceID. | |
| | | | | Contains the following attributes: | |
| | | | | type | |
| type | A | M | 1 | Specifies the type of Device ID. Allowed | unsignedByte |
| | | | | values are | |
| | | | | 0 - DVB Device ID | |
| | | | | 1 - 3GPP Device ID (IMEI)[3GPP TS 23.003] | |
| | | | | 2 - 3GPP2 Device ID (MEID)[3GPP2 | |
| | | | | C.S0072] | |
| | | | | 3-127 reserved for future use | |
| | | | | 128-255 reserved for proprietary use | |
| usage | A | M | 1 | If value==0, ID will be used for the purpose | boolean |
| | | | | of authentication. | |
| | | | | If value==1, ID will be used for indicating | |
| | | | | device that will receive content. | |
| ServiceEncryptionProtocol | E1 | O | 0 . . . 1 | Lists each service encryption protocol | string |
| | | | | supported by the device, including the | |
| | | | | mandatory ones. Defined values: “ipsec”, | |
| | | | | “srtp”, and “ISMACryp”. The device is | |
| | | | | allowed to include more identifiers, however | |
| | | | | depending on the protocols supported by the | |
| | | | | network they may be ignored. | |
| | | | | Note: This element is only included in the | |
| | | | | message if a service is to be delivered over | |
| | | | | Interaction channel. | |
| Purchase | E1 | M | 1 . . . N | Contains the list and price of items the user | |
| Item | | | | wants to order and the list of services the user | |
| | | | | wants to subscribe notification. | |
| | | | | Contains the following attributes: | |
| | | | | globalIDRef | |
| | | | | Contains the following elements: | |
| | | | | PurchaseDataReference | |
| | | | | Service | |
| globalIDRef | A | M | 1 | The identifier of the Purchase Item. The | anyURI |
| | | | | Purchase Item identifier is advertised in the | |
| | | | | PurchaseItem fragment of the Service Guide | |
| | | | | as GlobalPurchaseItemID and is inserted in | |
| | | | | this message in the same format. | |
| PurchaseDataReference | E2 | O | 0 . . . 1 | Contains the price information. | |
| | | | | This specifies the PurchaseData fragment in | |
| | | | | the Service Guide which is to be used for this | |
| | | | | subscription. | |
| | | | | Contains the following attribute | |
| | | | | idRef | |
| | | | | Contains the following Element: | |
| | | | | Price | |
| idRef | A | M | 1 | References the identifiers of PurchaseData | anyURI |
| | | | | Fragment advertised in Service Guide. | |
| Price | E3 | O | 0 . . . 1 | The price of the Purchase Item known to the | double |
| | | | | user from Service Guide. If PurchaseData in | |
| | | | | the Service Guide contains multiple price | |
| | | | | entries by currency, this element should be | |
| | | | | specified to indicate to the BSM the entry | |
| | | | | desired by the user. Price is expressed in | |
| | | | | fractional units (e.g. Cents). | |
| | | | | Contains the following attribute: | |
| | | | | currency | |
| currency | A | O | 0 . . . 1 | Specifies the currency codes defined in ISO | string |
| | | | | 4217 international currency codes. | |
| UserConsentAnswer | E2 | O | 0 . . . 1 | Signals whether user agreed to the Terms of | boolean |
| | | | | Use as represented by id of the related | |
| | | | | TermsOfUse element. | |
| | | | | true: User agrees the terms of the | |
| | | | | Terms of Use. | |
| | | | | false: User disagrees the terms of the | |
| | | | | Terms of Use. | |
| | | | | If this element is not present the interpretation | |
| | | | | is that the user has not read or understood the | |
| | | | | Terms of Use. | |
| id | A | M | 1 | The URI uniquely identifying the Terms of | anyURI |
| | | | | Use this ‘UserConsentAnswer’ relates to. | |
| Service | E2 | O | 0 . . . N | Reference of the Service. This element is only | |
| | | | | used for subscribing service-specific | |
| | | | | Notification | |
| | | | | Contains the following attributes: | |
| | | | | globalIDRef | |
| | | | | notification | |
| | | | | Note: This element is only used for the | |
| | | | | purpose of subscribing to service-specific | |
| | | | | Notification. In addition, this element should | |
| | | | | not be confused with the MBMS User Service | |
| | | | | ID (the latter is the equivalent MBMS | |
| | | | | designation for the concatenation of the | |
| | | | | attributes ‘PurchaseItemID.@gobalIDRef’ and | |
| | | | | ‘PurchaseData.@idRef’ in BCAST. | |
| globalIDRef | A | M | 1 | Unique ID of the Service, as represented by | anyURI |
| | | | | the GlobalServiceID. It is used to identify the | |
| | | | | Service. | |
| notification | A | M | 1 | Subscription to receive Notification Message | boolean |
| | | | | related to the Service over Interaction | |
| | | | | Channel. If notification = true, it means | |
| | | | | Notification over Interaction Channel is | |
| | | | | subscribed. If notification = false, it means | |
| | | | | Notification over Interaction Channel should | |
| | | | | not be delivered. | |
| DrmProfileSpecificPart | E1 | O | 0 . . . 1 | Service & Content Protection DRM-profile | |
| | | | | specific part. This part is MANDATORY to | |
| | | | | support for DRM Profile, and is not applicable | |
| | | | | to the Smartcard Profile. | |
| | | | | Contains the following attributes: | |
| | | | | rightsIssuerURI | |
| | | | | Contains the following element: | |
| | | | | BroadcastMode | |
| rightsIssuerURI | A | O | 0 . . . 1 | ID of the rights issuer associated with the | anyURI |
| Broadcast | | | | BSM. | |
| Mode | E2 | O | 0 . . . 1 | Indicates whether or not the device supports | boolean |
| | | | | the optional broadcast mode of operation for | |
| | | | | rights acquisition, in addition to the interactive | |
| | | | | mode of operation. | |
| SmartcardProfileSpecificPart | E1 | O | 0 . . . 1 | Service & Content Protection Smartcard | |
| | | | | Profile specific part. This part is | |
| | | | | MANDATORY to support for the Smartcard | |
| | | | | Profile, and is not applicable to the DRM | |
| | | | | Profile. | |
| | | | | Contains the following elements: | |
| | | | | ProtectionKeyID | |
| | | | | Note: This message is used to submit a request | |
| | | | | for SEK(s) or PEK(s) associated with a | |
| | | | | specific range of TEK values, due to | |
| | | | | unavailability of that key in the BCAST | |
| | | | | Terminal, necessary to enable play-back of | |
| | | | | protected recording. | |
| ProtectionKeyID | E2 | M | 1 . . . N | The 7-byte long concatenation of | unsignedLong |
| | | | | KeyDomainID and SEK/PEK ID | |
| | | | | corresponding to the content for which the | |
| | | | | SEK(s) or PEK(s) is requested. | |
| | | | | Contains the following attributes: | |
| | | | | timestampMin | |
| | | | | timestampMax | |
| timestamp | A | O | 0 . . . 1 | The lower bound of the range of STKM | hexBinary |
| Min | | | | timestamp values (4 bytes) for which the SEK | |
| | | | | or PEK is requested. | |
| timestamp | A | O | 0 . . . 1 | The upper bound of the range of STKM | hexBinary |
| Max | | | | timestamp values (4 bytes) for which the SEK | |
| | | | | or PEK is requested. | |

For the existing service request message corresponding to the subscription/purchase, though Device ID has a purpose for authentication on the terminal that sent the corresponding message, since the terminal information for actual service reception should also be included, there is a need for a method capable of specifying usage of the Device ID whether the corresponding Device ID has a purpose for authentication or is a terminal for performing service reception as it is included in the message along with the Usage element. After the purchase and subscription procedure is performed, the purchase result information shown in Table 8 may be provided to the terminal in step 735.

TABLE 8

| | | | | | Data |
|---|---|---|---|---|---|
| Name | Type | Category | Cardinality | Description | Type |
| ServiceResponse | E | | | Service Response Message | |
| | | | | Contains the following attributes: | |
| | | | | requestID | |
| | | | | globalStatusCode | |
| | | | | adaptationMode | |
| | | | | Contains the following elements: | |
| | | | | PurchaseItem | |
| | | | | DrmProfileSpecificPart | |
| requestID | A | O | 0 . . . 1 | Identifier for the corresponding Service | unsignedInt |
| | | | | request message. | |
| global | A | M | 1 | The overall outcome of the request, according | unsignedByte |
| Status | | | | to the return codes defined in section 5.11. | |
| Code | | | | | |
| Purchase | E1 | M | 1 . . . N | Describes the results of the request message of | |
| Item | | | | subscribing to or purchasing the | |
| | | | | PurchaseItem. For the DRM Profile, if | |
| | | | | subscription or purchase is successful, | |
| | | | | rightsValidityEndTime of PurchaseItem will | |
| | | | | be present. For either the DRM Profile or | |
| | | | | Smartcard Profile, in the case of | |
| | | | | subscription/purchase failure, | |
| | | | | itemWiseStatusCode will be present to | |
| | | | | indicate the reason why the request is not | |
| | | | | accepted by BSM. | |
| | | | | Contains the following attributes: | |
| | | | | globaIDRef | |
| | | | | itemwiseStatusCode | |
| globalID | A | M | 1 | The ID of the Purchase Item. A purchase item | anyURI |
| Ref | | | | is identified by the GlobalPurchaseItemID | |
| | | | | found in the PurchaseItem fragment. | |
| itemwise | A | O | 0 . . . 1 | Specifies an error code of each PurchaseItems | unsignedByte |
| StatusCode | | | | using GlobalStatusCode defined in the section | |
| | | | | 5.11. | |

After the purchase is completed, the BSM 715 performs steps 737˜747 for the transmission of an encryption key related to the corresponding service to the Terminal_2 713.

In step 737, the BSM 715 sends to a BSD/A 717 associated with BCAST Service Provider 703 a notification message delivery request message shown in Table 9, requesting the BSD/A 717 to send to the Terminal_2 713 a notification message including the information necessary for key reception such as information on the BSM 715 to which the corresponding terminal is connected to perform key reception.

TABLE 9

| | | | | | Data |
|---|---|---|---|---|---|
| Name | Type | Category | Cardinality | Description | Type |
| NTDReq | E | | | Specifies the Request message of Notification | |
| | | | | Message Delivery from NTG to NTDA. | |
| | | | | Contains the following attributes: | |
| | | | | ntdReqID | |
| | | | | entityAddress | |
| | | | | deliveryPriority | |
| | | | | Contains the following elements: | |
| | | | | TargetAddress | |
| | | | | NotificationMessage | |
| ntdReqID | A | M | 1 | Identifier of NTDReq | unsignedInt |
| entityAddress | A | M | 1 | Network Entity Address to receive the | anyURI |
| | | | | response of this message. | |
| deliveryPriority | A | O | 0 . . . 1 | Defines the delivery priority of this | boolean |
| | | | | Notification Message. NTG can request | |
| | | | | NTDA to deliver this notifcaiton message as | |
| | | | | high priority. If priority = true, it means high | |
| | | | | priority. If priority = false, it means general | |
| | | | | message. | |
| TargetAddress | E1 | O | 0 . . . N | Specifies TargetAddress to deliver | string |
| | | | | Notification Message. | |
| | | | | For service-specific notification, | |
| | | | | AccessReference or address under | |
| | | | | NotificationReception in ‘Access’ fragment | |
| | | | | can be possible value. | |
| | | | | If Notification message is delivered over | |
| | | | | interaction channel, the value can be e-mail | |
| | | | | address, IMSI, etc. | |
| | | | | If not given, Notification message SHALL be | |
| | | | | delivered to all users of the service provider | |
| | | | | using address defined in SGDD. | |
| | | | | Contains the following attributes: | |
| | | | | deliveryChannel | |
| | | | | AddressType | |
| deliveryChannel | A | M | 1 | Specifies the delivery channel | boolean |
| | | | | If deliveryChannel = false, Notificaiton | |
| | | | | Message SHALL be delivered over Broadcast | |
| | | | | Channel. | |
| | | | | If deliveryChannel = true, Notification | |
| | | | | Message SHALL be delivered over Interaction | |
| | | | | Channel. | |
| AddressType | A | M | 1 | Specifies the type of TargetAddress Value | unsignedByte |
| | | | | 0 - IPAddress | |
| | | | | 1 - anyURI | |
| | | | | 2 - IMSI | |
| | | | | 3-127: For Future Use | |
| | | | | 128-255: For Proprietary Use | |
| NotificationMessage | E1 | O | 0 . . . 1 | BCAST NotificationMessage format as | complexType |
| | | | | specified in section 5.14.3. The following rule | as |
| | | | | applies to child elements or attributes of | specified |
| | | | | NotificationMessage which are not relevant: If | in |
| | | | | the element/attribute has a minimum | section |
| | | | | cardinality of 0, it SHALL NOT be | 5.14.3 |
| | | | | instantiated. Otherwise, it SHALL be | |
| | | | | delivered as empty field. | |

Upon receipt of the notification message delivery request message, the BSD/A 717 sends in step 739 a notification message shown in Table 10 to the Terminal_2 713. In the notification message, a value indicating that the corresponding message is a message transmitted for key reception should be defined and included in Type, and information for key reception such as BSMAddress should be included.

TABLE 10

| | | | | | Data |
|---|---|---|---|---|---|
| Name | Type | Category | Cardinality | Description | Type |
| Notification | E | | | Notification Message | |
| Message | | | | Contains the following attributes: | |
| | | | | id | |
| | | | | version | |
| | | | | notificationType | |
| | | | | eventType | |
| | | | | validTo | |
| | | | | Contains the following elements: | |
| | | | | IDRef | |
| | | | | Title | |
| | | | | Description | |
| | | | | PresentationType | |
| | | | | Extension | |
| | | | | SessionInformation | |
| | | | | MediaInformation | |
| | | | | SGDD | |
| | | | | SGDDReference | |
| | | | | FragmentID | |
| | | | | AuxDataTrigger | |
| | | | | RecordingReservation | |
| | | | | PrivateExt | |
| id | A | NM/ | 1 | Identifier of Notification Message | anyURI |
| | | TM | | | |
| version | A | NM/ | 1 | Notification Message version information. It | unsignedInt |
| | | TM | | is to be used to check for Notification | |
| | | | | Message Redundancy and new Notification | |
| | | | | Messages. This field can be expressed as the | |
| | | | | first 32bits integer part of NTP time stamps. | |
| notificationType | A | NM/ | 1 | Notification Type. Allowed values are: | unsignedByte |
| | | TM | | 0 - this message is user-oriented message. | |
| | | | | such as notice from SP, emergency, etc. | |
| | | | | 1 - this message is terminal-oriented message, | |
| | | | | such as AuxData Trigger, etc. | |
| | | | | 2-127: For future use | |
| | | | | 128-255: For proprietary use | |
| eventType | A | NM/TM | 1 | Type of notification event carried in this | unsignedByte |
| | | | | Notification Message. See section 5.14.2 | |
| | | | | * Trigger added to Type | |
| validTo | A | NM/ | 0 . . . 1 | Valid time of Notification Message. This field | unsignedInt |
| | | TM | | expressed as the first 32bits integer part of | |
| | | | | NTP time stamps. | |
| | | | | If ‘validTo’ is specified, the Notification | |
| | | | | Message SHOULD be expired at the specified | |
| | | | | time. | |
| IDRef | E1 | NM/ | 0 . . . N | Fragment ID references of the main services | anyURI |
| | | TM | | or contents which the Notification Message is | |
| | | | | related to | |
| Title | E1 | NM/ | 0 . . . N | Title of Notification Message, possibly in | string |
| | | TM | | multiple languages. | |
| | | | | The language is expressed using built-in XML | |
| | | | | attribute ‘xml:lang’ with this element. | |
| Description | E1 | NM/ | 0 . . . N | Description or Messages of Notification, | string |
| | | TM | | possibly in multiple languages | |
| | | | | The language is expressed using built-in XML | |
| | | | | attribute ‘xml:lang’ with this element | |
| PresentationType | E1 | NM/ | 1 | Recommends the type of presentation for the | unsignedByte |
| | | TM | | received Notification Messages based on the | |
| | | | | priority of the Notification Message. Allowed | |
| | | | | values are: | |
| | | | | 0 - For high priority Notification Messages, | |
| | | | | Terminal MAY immediately render the | |
| | | | | message after interrupting all the applications. | |
| | | | | 1 - For medium priority Notification | |
| | | | | Messages, Terminal MAY immediately render | |
| | | | | the message, overlaying the present playing | |
| | | | | services. | |
| | | | | 2 - For low priority Notification Messages, | |
| | | | | Terminal MAY NOT immediately render the | |
| | | | | message, the user can see the stored message | |
| | | | | whenever he or she wants. | |
| | | | | 3-127: For future use | |
| | | | | 128-255: For proprietary use | |
| Extension | E1 | NM/ | 0 . . . N | Additional information related to this | |
| | | TM | | Notification Message. | |
| | | | | Contains following attribute: | |
| | | | | url | |
| | | | | Contains following sub-element: | |
| | | | | Description | |
| url | A | NM/ | 1 | URL containing additional information related | anyURI |
| | | TM | | to this notification. | |
| Description | E2 | NM/ | 0 . . . N | Description regarding the additional | string |
| | | TM | | information which can be retrieved from a | |
| | | | | web page. The language is expressed using | |
| | | | | built-in XML attribute ‘xml:lang’ with this | |
| | | | | element | |
| SessionInformation | E1 | NM/ | 0 . . . N | This element SHALL be present when the | |
| | | TM | | Notification Message carries pointer to | |
| | | | | another delivery session, for example for file | |
| | | | | download or update, SG download or update, | |
| | | | | or auxiliary data download. | |
| | | | | SessionInformation defines the delivery | |
| | | | | session information, transport object | |
| | | | | identifiers of the objects delivered through the | |
| | | | | indicated session, and URI as alternative | |
| | | | | method for delivery over interaction channel. | |
| | | | | After receiving Notification Message with | |
| | | | | SessionInformation. Terminal would access | |
| | | | | the relevant session specified by | |
| | | | | SessionInformation and take a proper action | |
| | | | | like receiving contents. | |
| | | | | Contains the following attributes: | |
| | | | | validFrom | |
| | | | | validTo | |
| | | | | usageType | |
| | | | | Contains the following elements: | |
| | | | | DeliverySession | |
| | | | | AlternativeURI | |
| | | | | Relatively long-lived auxiliary data associated | |
| | | | | with this Notification Message SHOULD be | |
| | | | | scheduled for distribution using the Service | |
| | | | | Guide. On the other hand, dynamic updates of | |
| | | | | auxiliary data MAY be delivered on the | |
| | | | | delivery session referenced by this | |
| | | | | SessionInformation. | |
| validFrom | A | NM/ | 0 . . . 1 | The first moment when the session for | unsignedInt |
| | | TM | | terminal to receive data is valid. This field | |
| | | | | expressed as the first 32bits integer part of | |
| | | | | NTP time stamps. | |
| validTo | A | NM/ | 0 . . . 1 | The last moment when the session for terminal | unsignedInt |
| | | TM | | to receive data is valid. This field expressed as | |
| | | | | the first 32bits integer part of NTP time | |
| | | | | stamps. | |
| usageType | A | NM/ | 0 . . . 1 | Defines the type of the object transmitted | unsignedByte |
| | | TM | | through the indicated delivery session. | |
| | | | | Allowed values are. | |
| | | | | 0 - unspecified | |
| | | | | 1 - files | |
| | | | | 2 - streams | |
| | | | | 3 - SGDD only | |
| | | | | 4 - mixed SGDD and SGDU | |
| | | | | 5 - notification | |
| | | | | 6-127 reserved for future use | |
| | | | | 128-255 reserved for proprietary use | |
| | | | | Note: the delivery session only carrying | |
| | | | | SGDUs is declared through ‘SGDD’ element | |
| | | | | or “SGDDReference” element in this | |
| | | | | Notification Message. | |
| | | | | Default: 0 | |
| Delivery | E2 | NM/ | 0 . . . 1 | Target delivery session information indicated | |
| Session | | TM | | by the Notification Message. | |
| | | | | Contains the following attributes: | |
| | | | | ipAddress | |
| | | | | port | |
| | | | | sourceIP | |
| | | | | transmissionSessionID | |
| | | | | Contains the following element: | |
| | | | | TransportObiectID | |
| ipAddress | A | NM | 1 | Destination IP address of the target delivery | string |
| | | TM | | session | |
| port | A | NM/ | 1 | Destination port of target delivery session | unsignedShort |
| | | TM | | | |
| sourceIP | A | NM/ | 0 . . . 1 | Source IP address of the delivery session | string |
| | | TM | | | |
| transmission | A | NM/ | 1 | This is the Transmission Session Identifier | unsignedShort |
| SessionID | | TM | | (TSI) of the session at ALC/LCT level. | |
| Transport | E3 | NM/ | 0 . . . N | The transport object ID (TOI) of the object | unsignedInt |
| ObjectID | | TM | | transmitted through the indicated delivery | |
| | | | | session | |
| AlternativeURI | E2 | NM/ | 0 . . . 1 | Alternative URI for receiving the object via | anyURI |
| | | TM | | the interaction channel. If terminal cannot | |
| | | | | access the indicated delivery session, the | |
| | | | | terminal can receive the objects associated | |
| | | | | with the Notification Message by | |
| | | | | AlternativeURI. | |
| Media | E1 | NO/ | 0 . . . 1 | This element SHALL be present when the | |
| Information | | TM | | Notification Message carries information for | |
| | | | | rendering support of the notification. | |
| | | | | Media Information is used to construct and | |
| | | | | render Notification Messages. | |
| | | | | The notification media objects declared below | |
| | | | | can be delivered over a file delivery session | |
| | | | | specified by ‘SessionInformation’ element, or | |
| | | | | be retrieved via interaction channel via URI of | |
| | | | | the media object. | |
| | | | | Contains the following elements: | |
| | | | | Picture | |
| | | | | Video | |
| | | | | Audio | |
| Picture | E2 | NO/ | 0 . . . N | Defines how to obtain a picture and MIME | |
| | | TM | | type. | |
| | | | | Contains the following attributes: | |
| | | | | mimeType | |
| | | | | pictureURI | |
| mimeType | A | NO/ | 0 . . . 1 | MIME type of Picture | string |
| | | TM | | | |
| pictureURI | A | NO/ | 0 . . . 1 | The URI referencing the picture | anyURI |
| | | TM | | | |
| Video | E2 | NO/ | 0 . . . N | Defines how to obtain a video and MIME | |
| | | TM | | type. | |
| | | | | Contains the following attributes: | |
| | | | | mimeType | |
| | | | | codec | |
| | | | | videoURI | |
| mimeType | A | NO/ | 0 . . . 1 | MIME type of Video | string |
| | | TM | | | |
| codec | A | NO/ | 0 . . . 1 | The codec parameters for the associated | string |
| | | TM | | MIME Media type. If the file's MIME type | |
| | | | | definition specifies mandatory parameters, | |
| | | | | these MUST be included in this string. | |
| | | | | Optional parameters containing information | |
| | | | | that can be used to determine as to whether the | |
| | | | | terminal can make use of the file SHOULD be | |
| | | | | included in the string. One example of the | |
| | | | | parameters defined for video/3GPP, | |
| | | | | video/3GPP2 is specified in [RFC 4281]. | |
| videoURI | A | NO/ | 0 . . . 1 | The URI referencing the video | anyURI |
| | | TM | | | |
| Audio | E2 | NO/ | 0 . . . N | Defines how to obtain a audio and MIME | |
| | | TM | | type. | |
| | | | | Contains the following attributes: | |
| | | | | mimeType | |
| | | | | codec | |
| | | | | AudioURI | |
| mimeType | A | NO/ | 0 . . . 1 | MIME type of Audio | string |
| | | TM | | | |
| codec | A | NO/ | 0 . . . 1 | The codec parameters for the associated | string |
| | | TM | | MIME Media type. If the file's MIME type | |
| | | | | definition specifies mandatory parameters, | |
| | | | | these MUST be included in this string. | |
| | | | | Optional parameters containing information | |
| | | | | that can be used to determine as to whether the | |
| | | | | terminal can make use of the file SHOULD be | |
| | | | | included in the string. One example of the | |
| | | | | parameters defined for audio/3GPP, | |
| | | | | audio/3GPP2 is specified in [RFC 4281]. | |
| audioURI | A | NO/ | 0 . . . 1 | The URI referencing the audio | anyURI |
| | | TM | | | |
| SGDD | E1 | NO/ | 0 . . . N | Service Guide Delivery Descriptor(s) | complexType |
| | | TO | | embedded in the Notification Message. | as |
| | | | | SGDD(s) described within this element | specified |
| | | | | SHALL relate to the currently bootstrapped | in |
| | | | | Service Guide. | [BCAST10-SG] |
| SGDDReference | E1 | NO/ | 0 . . . N | Reference to the Service Guide Delivery | |
| | | TM | | Descriptor(s). | |
| | | | | This element SHALL be present when the | |
| | | | | Notification Message notifies update of the | |
| | | | | SGDD(s) referenced by this element. All | |
| | | | | attributes of ‘SGDDReference’ element | |
| | | | | SHALL be supported by the network if | |
| | | | | ‘SGDDReference’ element is supported by the | |
| | | | | network. | |
| | | | | SGDD(s) referenced by this element SHALL | |
| | | | | relate to the currently bootstrapped Service | |
| | | | | Guide. | |
| | | | | Contains the following attributes: | |
| | | | | id | |
| | | | | version | |
| id | A | NO/ | 0 . . . 1 | Unique identifier of the SGDD within one | anyURI |
| | | TM | | specific SG | |
| version | A | NO/ | 0 . . . 1 | Version of SGDD | unsignedInt |
| | | TM | | | |
| Fragment | E1 | NO/ | 0 . . . N | Reference to the Service Guide fragments. | anyURI |
| Reference | | TM | | This element SHALL be present when the | |
| | | | | Notification Message notifies update of the | |
| | | | | SG fragments referenced by this element. | |
| | | | | All attributes of ‘FragmentReference’ element | |
| | | | | SHALL be supported by the network if | |
| | | | | ‘FragmentReference’ element is supported by | |
| | | | | the network. | |
| | | | | Contains the following attributes: | |
| | | | | id | |
| | | | | version | |
| id | A | NO/ | 0 . . . 1 | Identifier of the fragment | anyURI |
| | | TM | | | |
| version | A | NO/ | 0 . . . 1 | Version of the fragment | unsignedInt |
| | | TM | | | |
| AuxData | E1 | NO/ | 0 . . . N | This Element contains information to trigger | |
| Trigger | | TO | | the auxiliary data downloading and storage, or | |
| | | | | the auxiliary data insertion associated with | |
| | | | | main service or content. | |
| | | | | ‘globalContentID’ and/or ‘FilteringData’ can | |
| | | | | be used to identify and/or fetch the auxiliary | |
| | | | | data content, and/or FilteringData associated | |
| | | | | with the auxiliary data content. | |
| | | | | Note: The auxiliary data downloading trigger | |
| | | | | indicates that auxiliary data should be | |
| | | | | downloaded and stored when the filtering | |
| | | | | criteria are met. Absence of FilteringData in | |
| | | | | the downloading trigger implies that the | |
| | | | | auxiliary data should be stored. Persistence of | |
| | | | | storage is terminal implementation dependent. | |
| | | | | Contains the following Elements: | |
| | | | | GlobalContentID | |
| | | | | FilteringData | |
| | | | | PresentationRule | |
| GlobalContentID | E2 | NO/ | 0 . . . 1 | Globally Unique Identifier of the auxiliary | anyURI |
| | | TM | | data content. | |
| Filtering | E2 | NO/ | 0 . . . N | Reference to the location of the filtering | |
| Data | | TO | | related information associated with the | |
| | | | | AuxDataTrigger Notification Message, or the | |
| | | | | filtering-related information embedded within | |
| | | | | this Notification Message. | |
| | | | | Note: filtering related information can include | |
| | | | | attributes, values, rules, filter IDs, etc. | |
| | | | | Contains the following sub-elements: | |
| | | | | Location | |
| | | | | TargetProfile | |
| | | | | FilterIDs | |
| | | | | Either Location, TargetProfile, or FilterIDs, | |
| | | | | but not more than one of these sub-elements, | |
| | | | | MAY be present in FilteringData. | |
| Location | E3 | NO/ | 0 . . . 1 | Reference to the location of the filtering | anyURI |
| | | TM | | related information associated with the | |
| | | | | AuxDataTrigger, from which that data can be | |
| | | | | retrieved. | |
| TargetProfile | E3 | NO/ | 0 . . . N | Filter rules and/or attributes to be used in the | |
| | | TM | | selection of auxiliary data for downloading | |
| | | | | and storage, or insertion. | |
| | | | | The extensible list of TargetProfile for a | |
| | | | | particular AuxDataTrigger notification | |
| | | | | enables the filtering/customization of the | |
| | | | | auxiliary data triggered by the notification, | |
| | | | | according to any specified filtering | |
| | | | | characteristic, e.g. user preference, user age, | |
| | | | | user location, service provider, etc. | |
| | | | | The number of TargetProfile entries SHALL | |
| | | | | be the same as the number of | |
| | | | | SessionInformation entries, and specifically, | |
| | | | | TargetProfile 1 maps to SessionInformation 1, | |
| | | | | TargetProfile 2 maps to SessionInformation 2, | |
| | | | | and so on. | |
| | | | | Attribute: | |
| | | | | filterID | |
| | | | | Sub-elements: | |
| | | | | Attribute | |
| | | | | FilterRules | |
| | | | | Note: TargetProfile is intended to be used to | |
| | | | | identify the type of auxiliary data file | |
| | | | | associated with the AuxDataTrigger | |
| | | | | notification. As an example, for an ad | |
| | | | | insertion event, ‘attributeName’ = “URI” and | |
| | | | | ‘attributeValue’ = “advertisement” can be | |
| | | | | used to match against the URI identifiers of | |
| | | | | auxiliary data files stored on the terminal for | |
| | | | | the keyword “advertisement”. Such | |
| | | | | mechanism would identify all the | |
| | | | | advertisements stored on the terminal, for | |
| | | | | subsequent insertion selection based on filter | |
| | | | | rules/attributes. | |
| filterID | A | NO/ | 0 . . . 1 | Identity of the TargetProfile to be stored on | anyURI |
| | | TM | | the terminal for subsequent reference as a | |
| | | | | Filter ID sent as part of the FilterIDs (E3). | |
| Attribute | E4 | NO/ | 0 . . . N | Profile attribute. | |
| | | TM | | Contains the following attributes: | |
| | | | | name | |
| | | | | value | |
| name | A | NO/TM | 1 | Profile attribute name | string |
| value | A | NO/ | 1 | Profile attribute value. | string |
| | | TM | | | |
| FilterRules | E4 | NO/ | 0 . . . 1 | Filter rules that are used in the selection of | string |
| | | TM | | auxiliary data for downloading and storage, or | |
| | | | | insertion. | |
| FilterID | E3 | NO/ | 0 . . . N | Zero or more filter IDs used in the selection of | anyURI |
| | | TM | | auxiliary data for downloading and storage, or | |
| | | | | insertion. | |
| | | | | Each ad filter ID is an alias for a | |
| | | | | corresponding set of filter rules stored in the | |
| | | | | terminal. The rule set(s) in the FilterID list | |
| | | | | is(are) applied to the selection of the auxiliary | |
| | | | | data for downloading and storage, or insertion. | |
| | | | | The FilterID refers to the TargetProfile | |
| | | | | previously stored on the terminal. | |
| PresentationRule | E2 | NO/ | 0 . . . 1 | Specifies the presentation rules when the | |
| | | TM | | cached content should be rendered with this | |
| | | | | Notification Message. | |
| | | | | Contains the following attributes: | |
| | | | | renderingTime | |
| | | | | duration | |
| rendering | A | NO/ | 0 . . . 1 | Specifies the timing to start the presentation of | unsignedInt |
| Time | | TM | | the auxiliary data. | |
| | | | | In case eventType = 64 this element represent | |
| | | | | the time instant as the first 32bits integer part | |
| | | | | of NTP time for which the Notification | |
| | | | | Message is displayed or the auxiliary data | |
| | | | | insertion event occurs. | |
| | | | | In case eventType = 65, this element represent | |
| | | | | the offset in segments for which the auxiliary | |
| | | | | data insertion event occurs, relative to the start | |
| | | | | of the presentation of the associated main | |
| | | | | content. | |
| duration | A | NO/ | 0 . . . 1 | Time length of presentation of the auxiliary | unsignedShort |
| | | TM | | data in seconds. | |
| Recording | E1 | NO/TM | 0 . . . 1 | Reservation recording-related information | |
| Reservation | | | | Contains the following attributes: | |
| | | | | BSMAddress | |
| | | | | results | |
| | | | | trigger | |
| BSMaddress | A | NO/TM | 0 . . . 1 | Information on BSM with which Rx terminal | anyURI |
| | | | | should contact | |
| results | A | NO/TM | 0 . . . 1 | Result information such as reservation status | unsignedByte |
| | | | | of Rx terminal and reception completion | |
| trigger | A | NO/TM | 0 . . . 1 | Trigger information for key reception | ROAP |
| | | | | | Trigger |
| | | | | | or |
| | | | | | SmartcardProfileTrigger |
| PrivateExt | E1 | NO/ | 0 . . . 1 | An element serving as a container for | |
| | | TO | | proprietary or application-specific extensions. | |
| <proprietary | E2 | NO/TO | 0 . . . N | Proprietary or application-specific elements | |
| elements> | | | | that are not defined in this specification. These | |
| | | | | elements may further contain sub-elements or | |
| | | | | attributes. | |

In step 741, a mutual authentication procedure between the Terminal_2 713 and the BSM 715 is performed. In DRM of BCAST, for the mutual authentication, the Terminal_2 713 sends an authentication message for authentication, shown in Table 11, to a Rights Issuer (RI) in the BSM 715. Upon receipt of the authentication message, the RI in the BSM 715 sends an authentication response message shown in Table 12 in response to the authentication message, completing the mutual authentication between both entities.

TABLE 11
Authentication Request

| Parameter | Description | M/O | Data Type |
|---|---|---|---|
| Device ID | Identifier for Device | M | sring |
| RI ID | Identifier for RI | M | string |
| Device Nonce | Random number genrated | M | base64Binary |
| | by Device | | |
| Request Time | Present time | M | dateTime |
| Certificate Chain | Device certificate chain. | O | base64Binary |
| | It is not sent when it is | | |
| | specified in RI Context that | | |
| | RI already has Device | | |
| | certificate. | | |
| Peer Key Identifier | RI public key identifier | O | string |
| | that Device stores. | | |
| No OCSP Response | It indicates that RI has | O | base64Binary |
| | no need to send OCSP | | |
| | Response (Device already | | |
| | has OCSP Response). | | |
| Signature | Electronic signature | M | base64Binary |
| | for message | | |

TABLE 12
Authentication Response

| Parameter | Description | M/O | Data Type |
|---|---|---|---|
| Status | Authentication Request | M | unsignedByte |
| | processing result | | |
| Device ID | Identifier for Device | M | string |
| RI ID | Identifier for RI | M | string |
| Device Nonce | Value such as Nonce in | M | base64Binary |
| | Request message | | |
| Certificate Chain | RI certificate chain. | O | base64Binary |
| | When Peer key Identifier | | |
| | indicates a public key of | | |
| | RI itself or a Peer Key | | |
| | Identifier value is empty, | | |
| | there is no need to send RI | | |
| | Certificate Chain to Device. | | |
| OCSP Response | OCSP Response for | O | base64Binary |
| | Certificate Chain of RI | | |
| Signature | Electronic signature for | M | base64Binary |
| | message | | |

For Smartcard Profile, the same messages of Table 11 and Table 12 can be used, and in this case, the mutual authentication procedure may be performed through HTTPS. When the mutual authentication between the Terminal_2 713 and the BSM 715 is completed through step 741, the BSM 715 sends in step 743 a reservation request message shown in Table 13 to the Terminal_2 713, requesting reservation for the corresponding service. This message includes time information for the corresponding service and Trigger information for encryption key acquisition.

TABLE 13

| Name | Type | Category | Cardinality | Description | Data Type |
|---|---|---|---|---|---|
| RecordingReq | E | | | Recording reservation request message at terminal | |
| RequesterInfo | E1 | M | 1 | Information on terminal and user that first | |
| | | | | requested | |
| userID | E2 | M | 1 | User identifier | anyURI |
| Type | A | M | 1 | Identifier type | unsignedByte |
| DeviceID | E1 | M | 1 | Terminal information | anyURI |
| Type | A | M | 1 | Identifier type | |
| ContentID | E1 | M | 1 | Content identifier requiring Recording reservation | anyURI |
| Volume | A | M | 1 | Volume of Contents | |
| Schedule | E2 | M | 1 . . . N | Broadcasting time of corresponding contents | |
| startTime | A | M | 1 | Start time (NTP) | unsignedInt |
| endTime | A | M | 1 | End time (NTP) | unsignedInt |
| Trigger | E2 | M | 1 | Trigger information for key reception | |

Upon receipt of the reservation request message, the Terminal_2 713 sends in step 745 a reservation prepare complete message shown in Table 14 to the BSM 715 in response to the reservation request message.

TABLE 14

| | | | | | Data |
|---|---|---|---|---|---|
| Name | Type | Category | Cardinality | Description | Type |
| RecordingRes | E | | | Recording | |
| | | | | reservation | |
| | | | | request | |
| | | | | message at | |
| | | | | terminal | |
| globalStatus | E1 | M | 1 | Reservation | |
| Code | | | | result | |

In step 747, the Terminal_2 713 performs key acquisition for the corresponding service according to the procedure of a Protection Mechanism such as DRM and Smartcard, and receives the encryption key through a key delivery message shown in Table 15.

TABLE 15
Key Delivery

| Parameter | Description | M/O | Data Type |
|---|---|---|---|
| Device ID | identifier for Device | M | string |
| RI ID | Identifier for RI | M | string |
| Encryption Key | encryption key for encrypting | M | base64Binary |
| | SEAK/PEAK | | |
| Key Info | Encrypted SEAK/PEAK | M | base64Binary |
| ContentID | identifier of contents subject | M | anyURI |
| | to recording | | |
| startTime | start time (NTP) | O | unsignedInt |
| endTime | end time (NTP) | O | unsignedInt |
| Signature | Electronic signature for message | M | base64Binary |

When the Terminal_2 713 completes the key acquisition, the BSM 715 may notify the reservation completion status of the Terminal_2 713 through steps 749 and 751. For delivery request for a notification message and delivery of a notification message, the BSM 715 may reuse the messages used in steps 737 and 739, and however, generates the notification message including therein reservation completion-related information. After a lapse of a defined time, the Terminal_2 713 may prepare for broadcast service reception according to the previously known schedule information before a start of the broadcast service in step 771, and acquire and receive the corresponding service in step 753. The Terminal_2 713 may stores (records) the received contents in step 773, and after completion of the recording, may send in step 755 the completion results on the service reception to the BSD/A 717, or may send a Report to the server that processes the reception completion report. When the reception is completed, the BSD/A 717, while separately performing a billing procedure in step 775, can send the reception results of the Terminal_2 713 to the Terminal_1 711 in steps 757˜761. In step 757, the BSD/A 717 sends to the BSM 715 a service reception result notification request message shown in Table 16, which is a message for requesting notification of the reception results of the Terminal_2 713. Upon receipt of the service reception result notification request message, the BSM 715 sends the service reception results to the BSD/A 717 in response to the notification request message in step 759. Upon receipt of the service reception results, the BSD/A 717 delivers the service reception results to the Terminal_1 711 in step 761.

TABLE 16

| Name | Type | Category | Cardinality | Description | Data Type |
|---|---|---|---|---|---|
| NTEReq | E | | | Specifies the delivery message of Notification | |
| | | | | Event for generating Notification Message. | |
| | | | | Contains the following attributes: | |
| | | | | nteID | |
| | | | | entityAddress | |
| | | | | deliveryPriority | |
| | | | | Contains the following elements: | |
| | | | | NotificationEvent | |
| ntelID | A | M | 1 | Identifier of Notification Event | unsignedInt |
| entityAddress | A | M | 1 | Network Entity Address to receive the response of | anyURI |
| | | | | this message. | |
| deliveryPriority | A | O | 0 . . . 1 | Defines the priority of this notification event. This | boolean |
| | | | | information is applied to generate Notification | |
| | | | | Message in NTG. NTG may be ignored this field. | |
| Notification | E1 | M | 1 . . . N | Specifies the Notification Event, containing | |
| Event | | | | information to be included into the Notification | |
| | | | | Message. It is RECOMMENDED that the | |
| | | | | information is delivered in the form of BCAST | |
| | | | | Notification Message format (as specified in section | |
| | | | | 5.14.3). Other formats MAY be used only for NT-1. | |
| | | | | Contains the following sub-element: | |
| | | | | NotificationMessage | |
| Notification | E2 | O | 0 . . . 1 | BCAST NotificationMessage format as specified in | complexType |
| Message | | | | section 5.14.3. The following rule applies to child | as |
| | | | | elements or attributes of NotificationMessage which | specified |
| | | | | are not relevant: If the element/attribute has a | in section |
| | | | | minimum cardinality of 0, it SHALL NOT be | 5.14.3 |
| | | | | instantiated. Otherwise, it SHALL be delivered as | |
| | | | | empty field. | |
| Private | E2 | O | 0 . . . 1 | This container allows to use data formats not | |
| | | | | specified in BCAST. | |

Exemplary embodiments of the present invention receive the broadcast service through multiple terminals, so that the user, even though he/she cannot receive the service at its scheduled time, can receive and store the corresponding service through a proper one of the multiple terminals according to a location and time.

As is apparent from the foregoing description, in the mobile broadcasting system according to exemplary embodiments of the present invention, a user can register a plurality of terminals, and can receive a service through any one of the terminals registered during a service request.

In addition, according to exemplary embodiments of the present invention, the user, even though he/she cannot receive a service as scheduled, can receive and store the corresponding service through a proper terminal among a plurality of terminals according a location and time.

Further, according to exemplary embodiments of the present invention, the user can receive the same service through various terminals.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for receiving a broadcast service through a plurality of terminals in a mobile broadcasting system, the method comprising:
sending a registration request message for requesting registration of each of a plurality of terminals from a server associated with a broadcast service;
receiving a registration response message from the server in response to each registration request message;
sending a service request message to the server through one terminal of the plurality of terminals to request that the broadcast service be provided to the remaining terminals; and
receiving, by the remaining terminals, a service response message from the server and the broadcast service.

2. The method of claim 1, wherein the sending of the registration request message for each of the plurality of terminals comprises sending, by each of the plurality of terminals, the registration request message for itself to the server and further wherein the receiving of the registration response message from the server in response to each registration request message comprises receiving, by each of the plurality of terminals, the registration response message for itself from the server in response to a corresponding registration request message.

3. The method of claim 2, further comprising receiving, by the one terminal, registration information of the remaining terminals from the server.

4. The method of claim 2, further comprising:
sending, by the one terminal, to the server a request for information on all terminals registered in the server, and sending, by the server, information on all the terminals registered in the server to the one terminal.

5. The method of claim 2, wherein, when there is information on a terminal registered in the server, information on the registered terminal is included in the registration response message.

6. The method of claim 1, wherein the sending of the registration request message for each of the plurality of terminals comprises sending, by one of the plurality of terminals, a registration request message for each of the plurality of terminals to the server and further wherein the receiving of the registration response message comprises from the server in response to each registration request message comprises receiving, by the one of the plurality of terminals, a registration response message from the server for each of the plurality of terminals in response to a corresponding registration request message.

7. The method of claim 6, wherein, when there is information on a terminal registered in the server, information on the registered terminal is included in the registration response message.

8. The method of claim 1, wherein the registration request message includes at least one of a user identifier, a terminal identifier, and a terminal name.

9. The method of claim 1, wherein the registration response message includes at least one of a request result code, an identifier type, a terminal identifier and a terminal name.

10. The method of claim 1, wherein the service request message includes at least one of a processing result on a service request, an item identifier and price information.

11. The method of claim 1, wherein the service response message includes at least one of a processing result on a service request, an item identifier and currency information.

12. A method for providing a broadcast service through a plurality of terminals in a mobile broadcasting system, the method comprising:
upon receipt of a registration request message for each of a plurality of terminals, registering the plurality of terminals and sending a registration response message in response to each registration request message;
receiving a service request message through one terminal of the plurality of terminals, the service request message requesting that a broadcast service be provided to the remaining terminals; and
sending a service response message and the broadcast service to the remaining terminals.

13. The method of claim 12, wherein, when the registration request message for each of a plurality of terminals is received from each of the plurality of terminals, sending the registration response message to each of the plurality of terminals that sent a corresponding registration request message.

14. The method of claim 13, further comprising sending registration information for the remaining terminals to the one terminal.

15. The method of claim 13, further comprising: receiving a request for information on all registered terminals through the one terminal, and sending information on all the registered terminals to the one terminal.

16. The method of claim 13, further comprising, when there is information on a terminal registered in a server, sending information on the registered terminal in a response message to the terminal registration request.

17. The method of claim 12, wherein when the registration request message for each of the plurality of terminals is received from one of the plurality of terminals, sending the registration response message in response each registration request message to the one of the plurality of terminals.

18. The method of claim 17, further comprising, when there is information on a terminal registered in a server, sending information on the registered terminal in a response message to the terminal registration request.

19. The method of claim 12, wherein the registration request message includes at least one of a user identifier, a terminal identifier and a terminal name.

20. The method of claim 12, wherein the registration response message includes at least one of a request result code, an identifier type, a terminal identifier and a terminal name.

21. The method of claim 12, wherein the service request message includes at least one of a processing result on a service request, an item identifier and price information.

22. The method of claim 12, wherein the service response message includes at least one of a processing result on a service request, an item identifier and currency information.

23. A mobile broadcasting system for providing a broadcast service to a plurality of terminals, the system comprising:
a plurality of terminals for receiving the broadcast service; and
a server for receiving a registration request message for each of the plurality of terminals, for registering the plurality of terminals, for sending a registration response message in response to each registration request message, for receiving a service request message through one terminal of the plurality of terminals, the service request message requesting that the broadcast service be provided to the remaining terminals, and for sending a service response message and the broadcast service to the remaining terminals.

24. The system of claim 23, wherein the server receives a registration request message from each of the plurality of terminals, and sends the registration response message to each of the plurality terminals that sent a corresponding registration request message.

25. The system of claim 24, wherein the server sends registration information for the remaining terminals through the one terminal.

26. The system of claim 24, wherein the server receives a request for information on all registered terminals through the one terminal, and sends information on all the registered terminals to the one terminal.

27. The system of claim 24, wherein the server sends information on a registered terminal in the registration response message.

28. The system of claim 23, wherein the server receives a registration request for each of plurality of terminals from one of the plurality terminals, and sends the registration response message in response each registration request message to the one of the plurality of terminals.

29. The system of claim 28, wherein the server sends information on a registered terminal in the registration response message.

30. The system of claim 23, wherein the registration request message includes at least one of a user identifier, a terminal identifier and a terminal name.

31. The system of claim 23, wherein the registration response message includes at least one of a request result code, an identifier type, a terminal identifier and a terminal name.

32. The system of claim 23, wherein the service request message includes at least one of a processing result on a service request, an item identifier and price information.

33. The system of claim 23, wherein the service response message includes at least one of a processing result on a service request, an item identifier and currency information.
